(19) United States
(12) Patent Application Publication
(10) Pub. No.: US 2003/0001924 A1
(43) Pub. Date: Jan. 2, 2003

(54) Microinjector for jetting droplets of different sizes

(76) Inventors: Chung-Cheng Chou, Taipei City (TW); Tsung-Ping Hsu, Tao-Yuan Hsien (TW); In-Yao Lee, Taipei Hsien (TW); Wei-Lin Chen, Taipei City (TW); Hung-Sheng Hu, Kao-Hsiung City (TW)

Correspondence Address: NAIPO (NORTH AMERICA INTERNATIONAL PATENT OFFICE), P.O. BOX 506, MERRIFIELD, VA, 22116, US

(21) Appl. No.: 10/064,254

(22) Filed: Jun. 26, 2002

(30) Foreign Application Priority Data
Jun. 28, 2001 (TW) 090115841

(51) Int. Cl. B41J 2/14; B41J 2/16

(52) U.S. Cl. 347/48; 347/65

(57) ABSTRACT

A microinjector uses bubbles as virtual valves to eject droplets of different sizes. The microinjector is in fluid communications with a reservoir and has a substrate, an orifice layer, and a plurality of nozzles. The substrate has a manifold for receiving ink from the reservoir. The orifice layer is positioned on the top of the substrate so that a plurality of chambers are formed between the orifice layer and the top of the substrate. Each of the nozzles has an orifice and at least three bubble generating components. The bubble generating components are selectively driven by a driving circuit so that each nozzle can eject droplets of different sizes.

### BACKGROUND OF INVENTION

1. Field of the Invention

The present invention relates to a jet, and more particularly, to a jet that can eject droplets of different sizes.

2. Description of Related Art

Currently, jets spraying droplets of different sizes are widely used to improve the combustion efficiency of fuel in engines, or to increase the selectivity of ink jet printing. For example, when ink jet printers can print documents by way of ink droplets that have differing sizes, they are better able to improve both color variability and printing speed.

Please refer to FIG. 1, which is a side view of a jet 10 according to a related art. The jet 10 is disclosed in U.S. Pat. No. 4,251,824; “Liquid jet recording method with variable thermal viscosity modulation”. The jet 10 uses a plurality of heat generating bodies disposed on an axis of a liquid chamber 12 to provide energy individually or in turn, and in doing so generates a plurality of foam formations 31˜35 in different positions of the chamber 12 to eject droplets of different sizes for printing. Although the jet 10 can eject droplets of different sizes, there is an undesired characteristic in that the jet 10 also readily ejects satellite droplets. When the foam formations 31˜35 force out droplets 40, a tail of a droplet 40 may become separated from its associated body, forming another droplet in the period of expansion and contraction of the foam formations 31˜35. These separated droplets are called satellite droplets. The generation of such satellite drops causes printed documents to take on a fuzzy appearance, or a lessening of contrast. The satellite droplets generated by the jet 10 follow after the main droplets. When the jet 10 has a relative motion to a printed document, the satellite droplets are printed onto the document in positions to differ from those of their parent main droplets. Thus, the printing capability of the jet 10 is adversely affected by the satellite droplets.

U.S. Pat. Nos. 6,102,530 and 6,273,553 “Apparatus and method for using bubble as virtual valve in microinjector to eject fluid” disclosed an apparatus and method for forming a bubble within a microchannel of a microinjector to function as a valve mechanism between the chamber and manifold. These patents have been assigned to Acer Communications & Multimedia, presently known as BenQ Corporation, which is also the assignee of the present application.

### SUMMARY OF INVENTION

It is therefore a primary objective of the present invention to provide a jet which can eject droplets of different sizes without satellite droplets to solve the above-mentioned problem.

In a preferred embodiment, the present invention provides a jet which uses a bubble as a virtual valve to increase the resistance between a chamber and a manifold, or to interrupt flow communications between the chamber and the manifold. Another bubble is then used to squeeze fluid from the chamber. The jet is in flow communications with a reservoir, and comprises a substrate, an orifice layer and a plurality of nozzles. The substrate comprises a manifold, which is used to receive fluid from the reservoir. The orifice layer is disposed above the substrate so that a plurality of chambers are formed between the orifice layer and the substrate. Each of the nozzles comprises an orifice and at least three bubble generators. In the present invention, different bubble generators are driven selectively to generate two bubbles, leading to a plurality nozzles that jet droplets of different sizes from the orifice thereon.

These and other objectives of the present invention will no doubt become obvious to those of ordinary skill in the art after reading the following detailed description of the preferred embodiment, which is illustrated in the various figures and drawings.

### BRIEF DESCRIPTION OF DRAWINGS

FIG. 1 is a side view of a jet according to the prior art.

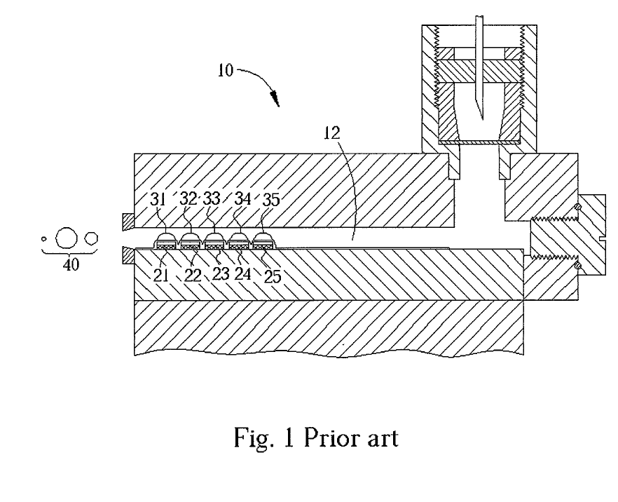

FIG. 2 is a schematic diagram of a jet according to the present invention.

FIG. 3 is a top view of a nozzle shown in FIG. 2.

FIG. 4 is a section view along line 4-4 of the jet shown in FIG. 2.

FIG. 5 is a cross-sectional diagram of the jet shown in FIG. 2 when a bubble is generated.

FIG. 6 is a cross-sectional diagram of the jet shown in FIG. 2 when a droplet is ejected.

FIG. 7 is a second cross-sectional diagram of the jet shown in FIG. 2 when a droplet is ejected.

FIG. 8 is a third cross-sectional diagram of the jet shown in FIG. 2 when a droplet is ejected.

FIG. 9 is a top view of a nozzle of a jet according to a second embodiment of the present invention.

FIG. 10 is a top view of a nozzle of a jet according to a third embodiment of the present invention.

FIG. 11 is a top view of a nozzle of a jet according to a fourth embodiment of the present invention.

FIG. 12 is a top view of a nozzle of a jet according to a fifth embodiment of the present invention.

FIG. 13 is a section view along line 13-13 of the nozzle shown in FIG. 12.

FIG. 14 is a section view along line 14-14 of the nozzle shown in FIG. 12.

FIG. 15 is a section view along line 15-15 of the nozzle shown in FIG. 12.

FIG. 16 is a section view of a nozzle of a jet according to a sixth embodiment of the present invention.

FIG. 17 is a top view of a nozzle of a jet according to a seventh embodiment of the present invention.

FIG. 18 is a top view of a nozzle of a jet according to an eighth embodiment of the present invention.

FIG. 19 is a top view of a nozzle of a jet according to a ninth embodiment of the present invention.

FIG. 20 is a section view along line 20-20 of the nozzle shown in FIG. 19.

### DETAILED DESCRIPTION

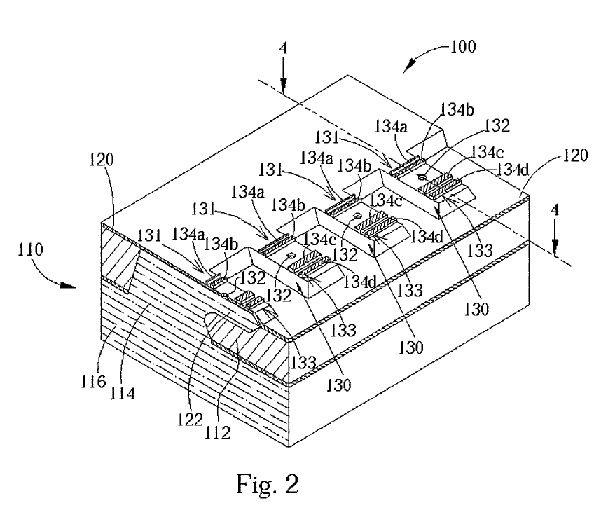

Please refer to FIG. 2, which is a schematic diagram of a jet 100 according to one embodiment of the present invention. The jet 100 is in flow communications with a reservoir 110 and comprises a substrate 112 positioned above the reservoir 110 and an orifice layer 120 positioned on the substrate 112 so that a plurality of chambers 122 are formed between the orifice layer 120 and the substrate 112. The substrate 112 comprises a manifold 114 for transporting fluid from the reservoir 110 to the jet 100. A plurality of nozzles 120 are disposed on the orifice layer 120, and each nozzle corresponds to one chamber 122. In the present embodiment, each nozzle 120 comprises an orifice 132 and four parallel bubble generators 134a, 134b, 134c and 134d. The bubble generators 134a and 134b are disposed on a first side 131 of the orifice 132, and the bubble generators 134c and 134d are disposed on a second side 133 of the orifice 132. In addition, the bubble generators 134a, 134b, 134c and 134d are electrically connected to a driving circuit (not shown), which drives the bubble generators 134a, 134b, 134c and 134d to generate bubbles in their corresponding chamber 122. The orifice 132 is formed on the orifice layer 120, and is positioned to correspond to the chamber 122. In the present embodiment, each of the bubble generators 134a, 134b, 134c and 134d is a heater that heats a fluid 116 inside the chamber 122 to generate bubbles. In a preferred embodiment of the present invention, the orifice layer 120 is composed of a low stress material with a residual stress lower than 300 MPa, such as a silicon rich nitride, to avoid the orifice layer 120 from being broken by the high residual stress incurred from fabricating the jet 100.

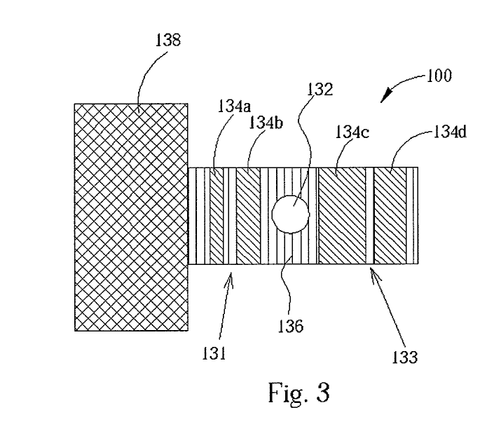

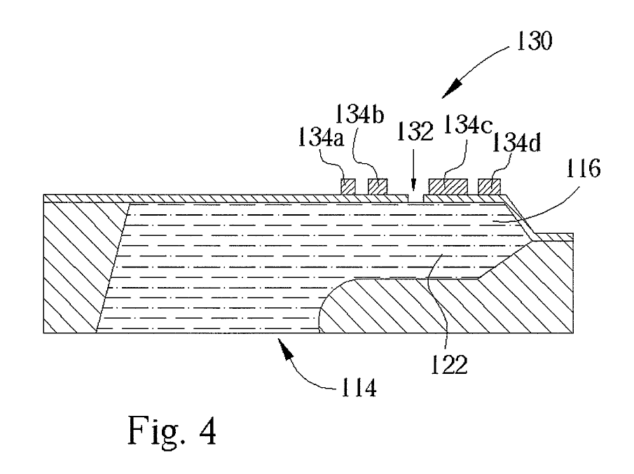

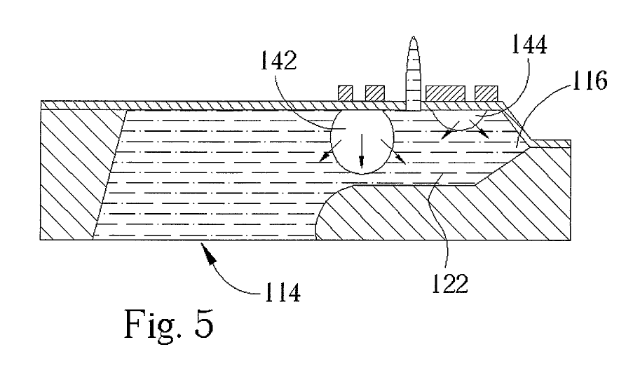

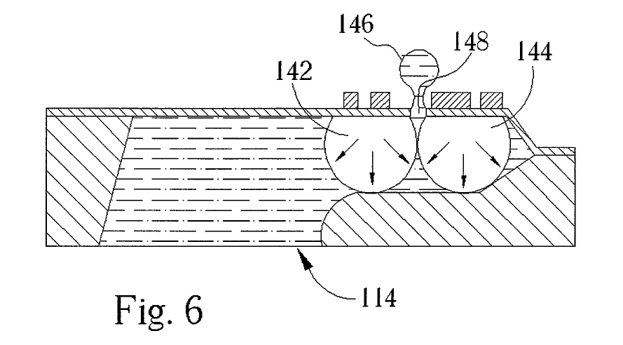

Please refer to FIG. 3 to FIG. 6. FIG. 3 is a top view of a nozzle 130 shown in FIG. 2. FIG. 4 is a sectional view along line 4-4 of the jet 100 shown in FIG. 2. FIG. 5 is a cross-sectional diagram of the jet 100 shown in FIG. 2 when a bubble is generated. FIG. 6 is a cross-sectional diagram of the jet 100 shown in FIG. 2 when a droplet is ejected. A first region 136 and a second region 138 are shown in FIG. 3. There is a corresponding chamber 122 under the first region 136, and a manifold 114 under the second region 138. Heaters 134a, 134b, 134c and 134d are disposed on the first side 131 and the second side 133, wherein the first side 131 is closer to the manifold 114 than the second side 133 is to the manifold 114. As a result, the heaters 134a and 134b positioned on the first side 131 are closer to the manifold 114 than the heaters 134c and 134d positioned on the second side 133. As shown in FIG. 4 to FIG. 6, the driving circuit (not shown) drives the heaters 134a and 134b disposed on the first side 131 to heat the fluid 116 inside the chamber 122 to generate a first bubble 142 and a second bubble 144 in turn. When the first bubble 142 is generated, the first bubble 142 prevents the fluid 116 inside the chamber 122 from flowing into the manifold 114, and hence a virtual valve is formed that isolates the chamber 122 from the manifold 114. As a result, cross-talk between adjacent chambers 122 is prevented. After the first bubble 142 is generated, the heaters 134c and 134d are driven by the driving circuit to generate a second bubble 144. As the second bubble expands, the pressure of the fluid 116 inside the chamber 122 increases until a droplet 146 is ejected. As the first bubble 142 and the second bubble 144 continue to expand, they approach each other as shown in FIG. 6. When the two bubbles combine, they stop forcing the fluid 116. Momentum carries the completed droplet 146 from the orifice 132. The tail of the droplet 146 is cut suddenly so that no satellite droplet is generated.

The driving circuit can drive the heaters 134a, 134b, 134c and 134d selectively to heat the fluid 116 inside the chamber 122 so that droplets of different sizes are ejected from the orifice 132. More specifically, when the driving circuit drives the heaters 134a and 134b positioned on the first side, the driving circuit may drive the heater 134a or 134b to heat fluid 116. Controlling the amount of heat supplied by the heater 134a and 134b to the fluid 116 causes first bubbles 142 of different sizes to be generated. In the same manner, the driving circuit can also control the heaters 134c and 134d to provide different amounts of heat to the fluid 116 so that second bubbles 144 of different sizes are generated. Since an interval between the heater 134a and the orifice 132 is larger than an interval between the heater 134b and the orifice 132, and similarly an interval between the heater 134d and the orifice 132 is larger than an interval between the heater 134c and the orifice 132, so the amount of residual fluid 116 between two bubbles 142 and 144 is different if different heaters 134a, 134b, 134c and 134d are driven. Even with the same amount of energy being provided to the heater 134a and the heater 134b, droplets of different sizes are generated when driving the heaters 134a and 134c as versus the heaters 134b and 134c, because between heaters 134a and 134c there is more residual fluid 116 than between heaters 134b and 134c. Thus, by driving the heaters 134a, 134b, 134c or 134d selectively, bubbles of different sizes are generated to eject different amounts of fluid 116 so that droplets of different sizes are ejected from the orifice 132 of the nozzle 130.

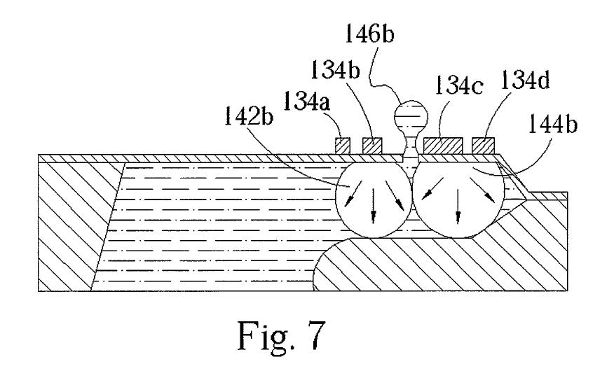

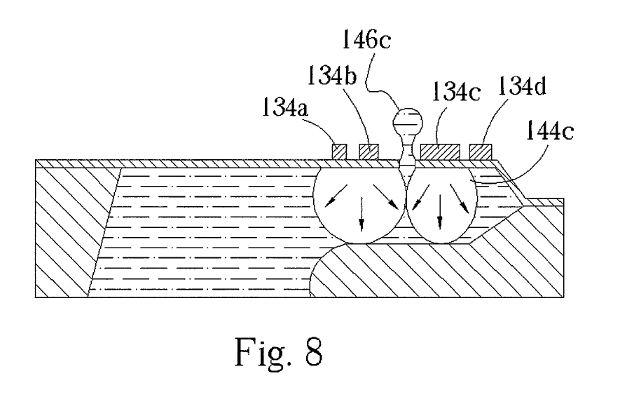

Please refer to FIG. 7 and FIG. 8. FIG. 7 is a second cross-sectional diagram of the jet 100 shown in FIG. 2 when a droplet is ejected. FIG. 8 is a third cross-sectional diagram of the jet 100 shown in FIG. 2 when a droplet is ejected. Please refer to FIG. 7 with reference to FIG. 6. A first bubble 142b generated by the heater 134b is smaller than the first bubble 142 generated by the heaters 134a and 134b. Thus, when the heater 134c and 134d heats the fluid 116 to generated a second bubble 144b, the residual fluid 116 between the first bubble 142b and the second bubble 144b is less than that between the first bubble 142 and the second bubble 144, and so a droplet 146b ejected from the orifice 132 is smaller than the droplet 146. Please refer to FIG. 8 with reference to FIG. 6. A second bubble 144c is generated by the heater 134c so that a droplet 146c ejected from the orifice 132 is smaller than the droplet 146. It should be emphasized that driving circuit is not restricted to driving the heaters 134a, 134b, 134c and 134d to the three methods mentioned above. Other methods are also possible, such as generating a first bubble by both the heaters 134a and 134b, or by only one of the heaters 134a and 134b. Similarly, the second bubble may be generated by both the heaters 134c and 134d, or by only one of the heaters 134c and 134d. The present invention may utilize different methods of driving the heaters 134a, 134b, 134c and 134d selectively to change the thermal energy supplied to the fluid 116 so that the first bubbles and the second bubbles of different sizes are generated, and hence droplets of different sizes are ejected.

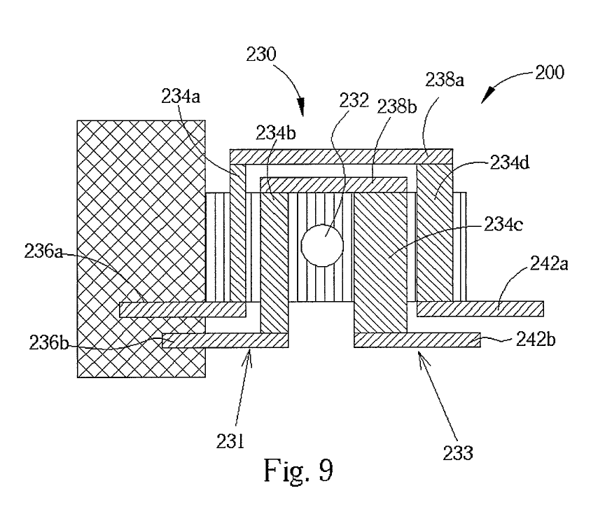

Please refer to FIG. 9. FIG. 9 is a top view of a jet 200 according to a second embodiment of the present invention. Each nozzle 230 of the jet 200 comprises an orifice 232 and four bubble generators 234a, 234b, 234c and 234d, wherein the four bubble generators are all heaters disposed on a first side 231 and a second side 233 of the orifice 232. The heater 234a is electrically connected to a signal wire 236a and connected to the heater 234d via a conducting wire 238a in series. In addition, the heater 234d is electrically connected to a grounded wire 242a and the heater 234c is electrically connected to a grounded wire 242b. Thus, the signal wire 236a, the heater 234a, the conducting wire 238a, the heater 234d and the grounded wire 242a are electrically connected in series so that a circuit is formed. The signal wire 236b, the heater 234b, the conducting wire 238b, the heater 234c and the grounded wire 242b are electrically connected in series and form another circuit. When the driving circuit drives the heaters 234a, 234b, 234c and 234d to generate a first bubble and a second bubble in their corresponding chambers, a voltage is applied to the signal wire 236a and signal wire 236b. After the voltage is applied to the signal wire 236a, the heater 234a and the heater 234d heat fluid inside the corresponding chambers respectively. In the same manner, after the voltage is applied to the signal wire 236b, the heaters 234b and 234c also heats fluid inside corresponding chambers, respectively. The cross-sectional area of the heater 234a is smaller than that of 234d, and so the resistance of the heater 234a is larger than that of the heater 234d under otherwise similar conditions such as length, thickness and material. As a result, when the driving circuit applies a voltage to the signal wire 236a, the heater 234a generates a first bubble earlier than the heater 234d generates a second bubble. In the same manner, since a cross-sectional area of the heater 234b is larger than that of the heater 234c, a resistance of the heater 234b is larger than that of the heater 234c with the same length, thickness and material. Thus, the heater 234b generates a first bubble earlier than the heater 234c generates a second bubble when the driving circuit applies a voltage to the signal wire 236b. Of course, the methods used for connecting heaters according to the present invention are not restricted to those mentioned above. The same effect can be achieved by parallel connections. For example, the heaters disposed on the first side 231, such as 234a or 234b, can be electrically connected in parallel to the heaters disposed on the second side 233, such as 234c or 234d, and both of the heaters connected in parallel are then electrically connected to a signal wire, such as 236a or 236b, and a grounded wire, such as 242a or 242b. Note that as the two heaters are connected in parallel, the resistance of the heater disposed on the first side 231 must be smaller than that of the heater disposed on the second side. As a result, when the driving circuit applies a voltage to the two paralleled heaters, the heater 231 disposed on the first side 231 generates a first bubble which functions as a virtual valve earlier than the heater disposed on the second side 233. In addition, the driving circuit can apply a voltage to the signal wire 236a and 236b simultaneously so that the heaters 234a, 234b, 234c and 234d heat fluid inside the corresponding chamber to generate a first bubble and a second bubble. The driving circuit can also apply a voltage to a single signal wire 236a or 236b so that only one series circuit, which may include the heaters 234a and 234d or the heaters 234b and 234c, heats fluid. Thus, the heaters 234a, 234b, 234c and 234d are driven selectively, and droplets of different sizes are ejected from the orifice 232.

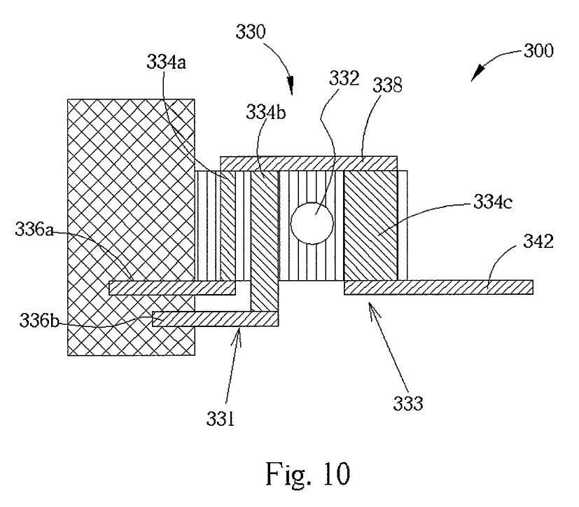

Please refer to FIG. 10, which is a top view of a nozzle 330 of a jet 300 according to a third embodiment of the present invention. Each nozzle 330 of the jet 300 comprises an orifice 332 and three bubble generators 334a, 334b and 334d which are electrically connected to a driving circuit (not shown). Each of the bubble generators is a heater, wherein the heaters 334a and 334b are disposed on a first side 331 of the orifice 332, and the heater 334c is disposed on a second side 333 of the orifice 332. As shown in FIG. 10, the heater 334a is electrically connected to a signal wire 336a and connected to the heater 334c in series via a conducting wire 338. The heater 334c is electrically connected to a grounded wire 342. Thus, the signal wire 336a, the heater 334a, the conducting wire 338, the heater 334c and the grounded wire 342 form a circuit. The signal wire 336b, the heater 334b, the conducting wire 338, the heater 334c and the grounded wire 342 form another circuit. When the driving circuit drives the heaters 334a, 334b, 334c to generate first bubbles and second bubbles in their corresponding chamber, a voltage is applied to the signal wire 336a and the 336b. In a preferred embodiment of the present invention, the driving circuit can apply voltages to the signal wire 336a and 336b simultaneously so that the heaters 334a, 334b and 334c heat fluid inside the corresponding chamber to generate first bubbles and second bubbles. The driving circuit can also apply a voltage to either the conducting wire 336a or the conducting wire 336b so that only one of the heaters 334a and 334b heats fluid to generate a first bubble. In the present embodiment, the driving circuit controls the amount of energy supplied to the heaters 334a and 334b on the first side 331 of the orifice 332 to change the sizes of bubbles. As a result, droplets of different sizes are ejected from the orifice 332.

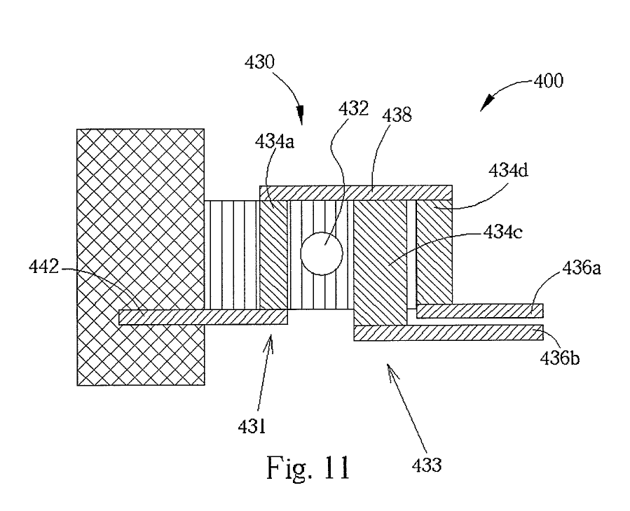

Please refer to FIG. 11, which is a top view of a nozzle 430 of a jet 400 according to a fourth embodiment of the present invention. Each nozzle 430 of the jet 400 comprises an orifice 432 and three heaters 434a, 434c and 434d, which are electrically connected to a driving circuit. The heater 434a is disposed on a first side 431 of the orifice 432 and the heaters 434c and 434c are disposed on a second side 433 of the orifice 432. As shown in FIG. 11, the heater 434d is electrically connected to a signal wire 436a and connected to the heater 434a via a conducting wire 438 in series. The heater 434c is electrically connected to a signal wire 436b and connected to the heater 436a via the conducting wire 438. The heater 434a is electrically connected to a grounded wire 442. Thus, the signal wire 436a, the heater 434d, the conducting wire 438, the heater 434a and the grounded wire 442 form a circuit. The signal wire 436b, the heater 434c, the conducting wire 438, the heater 434a and the grounded wire 442 form another circuit. As the driving circuit drives the heaters 434a, 434c and 434d to generate a first bubble and a second bubble in their corresponding chamber, a voltage is applied to the signal wire 436a and 436b, wherein the driving circuit can apply the voltage to the signal wire 436a and 436b so that the heaters 434a, 434c and 434d can heat fluid inside the corresponding chamber to generate first bubbles and second bubbles. The driving circuit can also apply a voltage to one signal wire 436a or 436b so that only one of the heaters 434c and 434d heats fluid to generate a second bubble. In the present embodiment, the driving circuit simultaneously controls the energy supplied to the heaters 434c and 434d disposed on the second side 433 of the orifice 432 to change the sizes of second bubbles so that droplets of different sizes are ejected from the orifice 432.

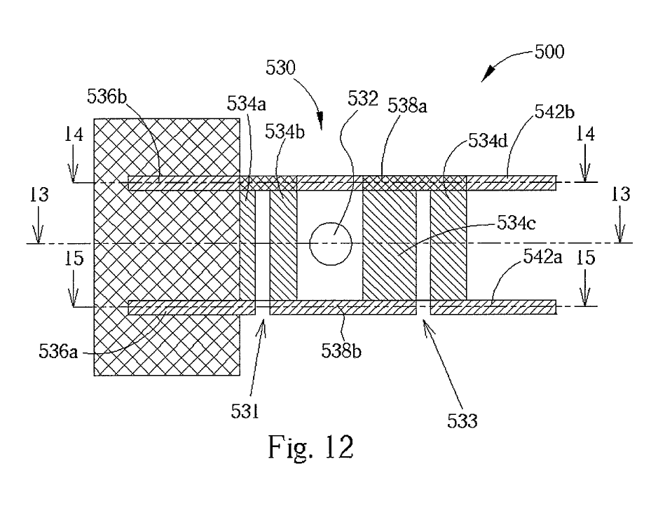

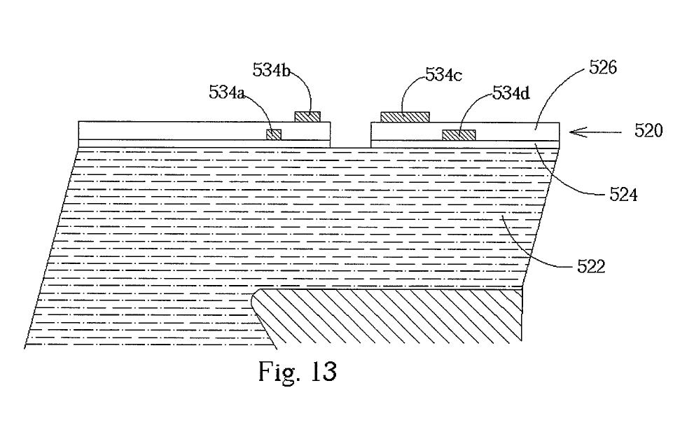

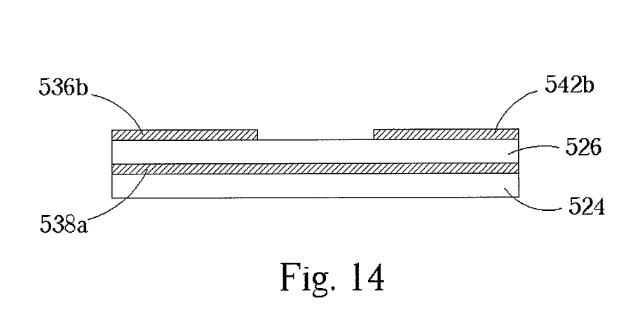

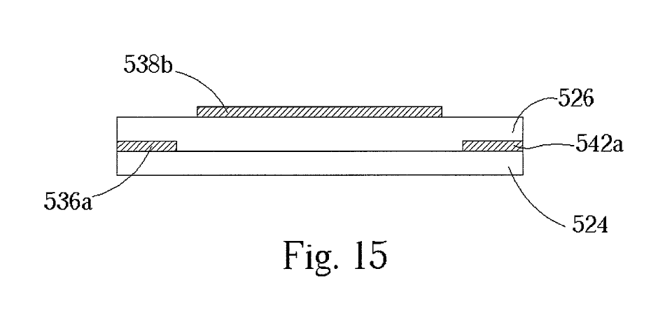

Please refer FIG. 12 to FIG. 15. FIG. 12 is a top view of a nozzle 530 of a jet 500 according to a fifth embodiment of the present invention. FIG. 13 is a sectional view along line 13-13 of the nozzle 530. FIG. 14 is a sectional view along line 14-14 of the nozzle 530. FIG. 15 is a sectional view along line 15-15 of the nozzle 530. The jet 500 is similar to the jet 200. The major difference is that the jet 500 comprises two parallel structure layers, a first structure layer 524 and a second structure 526, and heaters disposed on the first structure layer 524 and the second structure layer 526. As shown in FIG. 12, each nozzle 530 of the jet 500 comprises an orifice 532 and four heaters 534a, 534b, 534c and 534d. The heaters 534a and 534b are disposed on the first side 531 of the orifice 532, and the 534c and 534d are disposed on the second side 533 of the orifice 532. The heaters 534a and 534d are disposed on the first structure layer 524, and the heaters 534b and 534c are disposed on the second structure layer 526. The heater 534a is electrically connected to a signal wire 536a, and connected to the heater 534d in series via a conducting wire 538a. The heater 534b is electrically connected to a signal wire 536b, and connected to the heater 534c in series via a conducting wire 538. In addition, the heater 534d is electrically connected to a grounded wire 542a and the heater 534c is electrically connected to a grounded wire 542b. Thus, the signal wire, the heater 534a, the conducting wire 538a, the heater 534d and the grounded wire 542a form a series circuit. The signal wire 536b, the heater 534b, the conducting wire 538b, the heater 534c and the grounded wire 542b form another series circuit. As described above, the heaters 534a and 534b, and the heaters 534c and 534d, are disposed on the first structure layer 524 and the second structure layer 526, respectively. In a comparison with the jet 200, the jet 500 forms the two series circuits within a smaller area so that the jet 500 comprises more nozzles 530 in the same unit of area. When the driving circuit drives the heaters 534a, 534b, 534c and 534d to generate first bubbles and second bubbles in corresponding chambers, a voltage is applied to the signal wire 536a and 536b. When the voltage is applied to the signal wire 536a, the heater 534a and 534d heat fluid inside corresponding chambers, respectively. In the same manner, when a voltage is applied to the signal wire 536b, the heaters 534b and 534c also heat fluid inside corresponding chambers, respectively. In addition, the driving circuit can apply a voltage to the signal wires 536a and 536b at the same time so that the heaters 534a, 534b, 534c and 534d heat fluid inside corresponding chambers 522 to generate first bubbles and second bubbles simultaneously. The driving circuit can apply a voltage to one of the signal wires 536a and 536b, in which case only one circuit operates. The driving circuit may drive the heaters 534a and 534d, or the heaters 534b and 534c disposed on the other circuit. As a result, the heaters 534a, 534b, 534c and 534d can be driven selectively so that droplets of different sizes are ejected from the orifice 532.

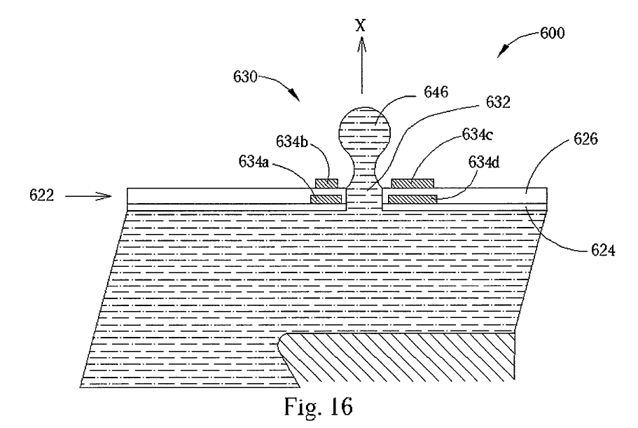

Please refer to FIG. 16, which is a sectional view of a nozzle 630 of a jet 600 according to a sixth embodiment of the present invention. The jet 600 is similar to the jet 500. The jet 600 comprises an orifice layer 622. The orifice layer 622 further comprises two structure layers 624 and 626. Each nozzle 630 of the jet 600 comprises heaters 634a, 634b, 634c and 634d disposed on the two structure layers 624 and 626. In comparison with the jet 500, the heaters 634a and 634b and the heaters 634c and 634d of the jet 600 are disposed along the same direction, respectively. As shown in FIG. 16, a droplet 646 formed by the nozzle 630 is ejected along a direction X from the orifice 632. The heaters 634a and 634b linearly disposed on the structure layers 624 and 626 along the direction X. The heaters 636d and 636c are also linearly disposed on the structure layers 624 and 626 along the direction X. As a result, more nozzles 630 of the jet 600 can be disposed in the same unit area than those of the jet 500.

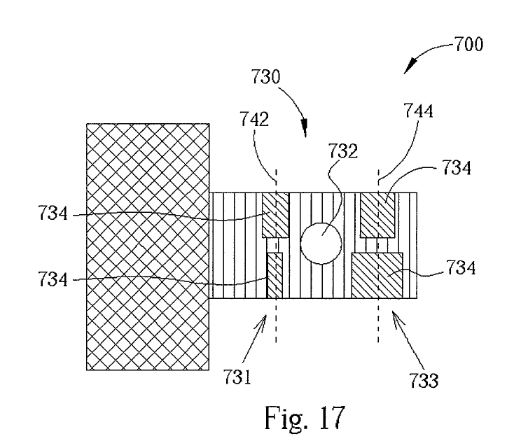

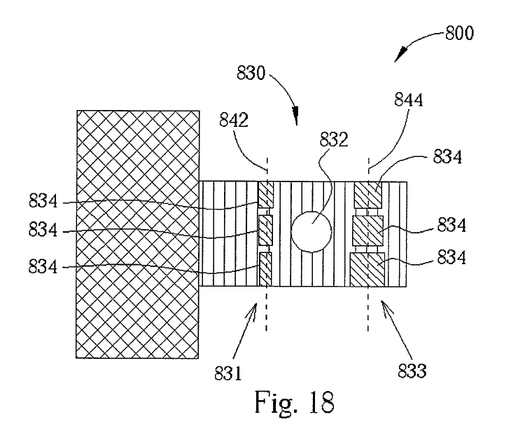

In the embodiments mentioned above, the bubble generators are disposed in parallel on the first side and the second side of the orifice. However, the present invention is not limited to such embodiments. Please refer to FIG. 17 and FIG. 18. FIG. 17 is a top view of a nozzle 730 of a jet 700 according to a seventh embodiment of the present invention. FIG. 18 is a top view of a nozzle 830 of a jet 800 according to an eighth embodiment of the present invention. As shown in FIG. 17, each nozzle 730 of the jet 700 comprises a bubble generator 732 on a first side 731 of the orifice 732 disposed on a first line 742. The nozzle 730 further comprises a bubble generator 734 on a second side 733 of the orifice 732 disposed on a second line 744, wherein the first line 742 and the second line 744 are parallel. As shown in FIG. 18, each nozzle 830 of the jet 800 comprises a bubble generator 832 on a first side 831 of the orifice 832 disposed on a first line 842. The nozzle 830 further comprises a bubble generator 834 on a second side 833 of the orifice 832 disposed on a second line 844, wherein the first line 842 and the second line 844 are parallel. Thus, the jet 800 comprises more bubble generators 834 so that there is a greater variability in the number of potential driving methods than found in the other embodiments. This, in turn, means that droplets of greater variety of sizes are possible from the nozzle 830.

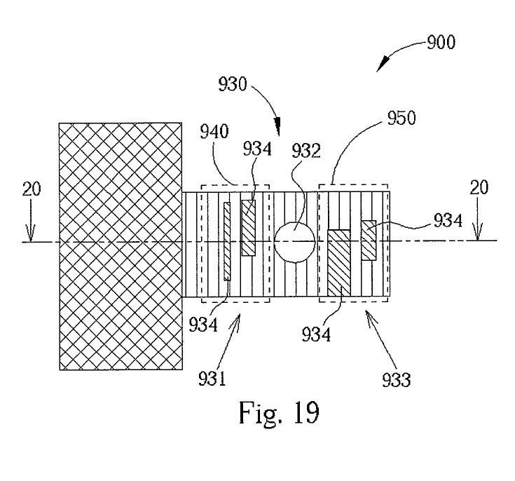

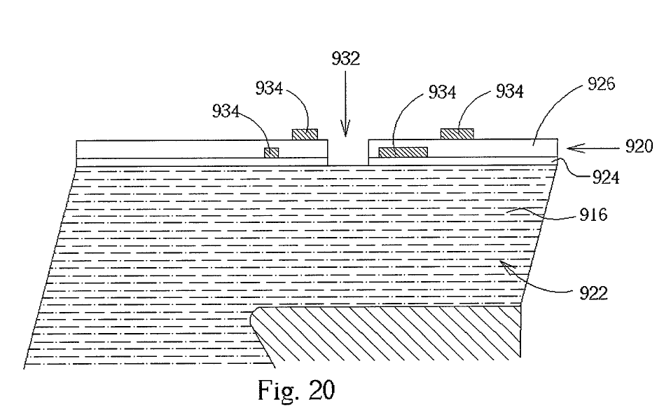

The bubble generators can be disposed on other ways, such as a mixed mode of horizontal and vertical directions. Please refer to FIG. 19 and FIG. 20. FIG. 19 is a top view of a nozzle 930 of a jet 900 according to a ninth embodiment of the present invention. FIG. 20 is a sectional view along line 20-20 of the nozzle 930 shown in FIG. 19. The jet 900 comprises an orifice layer 920 comprising two structure layers 924 and 926. A first group 940 of bubble generators is disposed on a first side 931 of the nozzle 930 and a second group 950 of bubble generators is disposed on a second side 933 of the nozzle 930. Both the first and second group 940 and 950 comprise a plurality of bubble generators, and each of the bubble generators is disposed on the two structure layers 924 and 926. Each bubble generator is a heater, and is independently controlled to generate bubbles in its corresponding chamber 922. Thus, bubbles are generated by controlling bubble generators on the both sides of the nozzles 930 to squeeze fluid inside the chambers 922 out of the orifice 932 so that droplets of different sizes are ejected.

In contrast to the prior art jet, the jet according to the present invention comprises a plurality of nozzles comprising at least three bubble generators electrically connected to a driving circuit. A plurality of bubble generators are divided into two groups disposed on the first side and the second side of the orifice, which generate a first bubble and a second bubble in a corresponding chamber. The first bubble functions as a virtual valve to protect adjacent chambers from cross-talk. Both the first and second sides comprise at least one bubble generator, and at least one side comprises at least two bubble generators. The driving circuit drives the plurality of bubble generators selectively to generate droplets of different sizes. In addition, since the nozzles generate the first bubble and second bubble in order, a tail of the droplet is suddenly cut as the second bubble squeezes fluid out of the orifice. Therefore, no satellite droplets are formed in the present invention. In addition to the purpose of improving the variability of colors and printing speed of ink jet printers, the present invention can also be used to improve fuel combustion efficiency in engines.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A jet in flow communications with a reservoir comprising:
a substrate having a manifold for receiving fluid from the reservoir;
an orifice layer disposed above the substrate so that a plurality of chambers are formed between the orifice layer and the substrate; and
a plurality of nozzles that are disposed on the orifice layer and correspond to the plurality of chambers for ejecting the fluid in the chambers so as to form a plurality of droplets, each of the nozzles comprising:
an orifice formed on the orifice layer; and
at least three bubble generators electrically connected to a driving circuit and disposed at a first side of the orifice and a second side of the orifice, at least two of the bubble generators disposed at one of either the first side or the second side, and at least one of the bubble generators disposed at the other of the first side and the second side, the driving circuit driving the bubble generator(s) disposed at the first side to generate a first bubble in a corresponding chamber and driving the bubble generator(s) disposed at the second side to generate a second bubble in the corresponding chamber; wherein the driving circuit drives the bubble generators selectively so that each of the nozzles is capable of ejecting droplets of different sizes.

2. The jet of claim 1 wherein an interval between the manifold and the first side is less than an interval between the manifold and the second side.

3. The jet of claim 2 wherein the first bubble is used as a virtual valve for restricting fluid between the first bubble and the second bubble to avoid flowing to the manifold when the second bubble is generated.

4. The jet of claim 1 wherein each of the bubble generators is a heater, the driving circuit drives the heater(s) disposed at the first side to heat fluid in the corresponding chamber so as to generate the first bubble, and the driving circuit drives the heater(s) disposed at the second side to heat fluid in the corresponding chamber so as to generate the second bubble.

5. The jet of claim 4 wherein an interval between the manifold and the first side is less than an interval between the manifold and the second side.

6. The jet of claim 5 wherein the first bubble is used as a virtual valve for restricting fluid between the first bubble and the second bubble to avoid flowing to the manifold when the second bubble is generated.

7. The jet of claim 4 wherein there is at least one heater disposed at the first side and connected in series to one of the heater(s) disposed at the second side, wherein resistance of the heater disposed at the first side is greater than resistance of the heater disposed at the second side.

8. The jet of claim 7 wherein each of the heater(s) disposed at the first side connects in series to one of the heater(s) disposed at the second side.

9. The jet of claim 7 wherein at least two heaters are disposed at the first side, and each of the nozzles comprises a leading wire for connecting one of the heater(s) disposed at the second side with the heaters disposed at the first side, and the driving circuit applies a voltage on at least one of the heaters disposed at the first side to generate the first bubble and the second bubble simultaneously.

10. The jet of claim 7 wherein at least two heaters are disposed at the second side, and each of the nozzles comprises a leading wire for connecting one of the heater(s) disposed at the first side with the heaters disposed at the second side, and the driving circuit applies a voltage on at least one of the heaters disposed at the second side to generate the first bubble and the second bubble simultaneously.

11. The jet of claim 4 wherein there is at least one heater disposed at the first side connected in parallel to one of the heater(s) disposed at the second side, wherein a resistance of the heater disposed at the first side is less than a resistance of the heater disposed at the second side.

12. The jet of claim 4 wherein the orifice layer comprises at least two structure layers arranged in parallel, and there is at least one heater disposed on each of the structure layers.

13. The jet of claim 12 wherein the droplets are ejected from the orifice along an ejection direction, and at least two of the heaters are disposed on the two structure layers linearly along the ejection direction.

14. The jet of claim 1 wherein the droplets are ejected from the orifice along an ejection direction, and the bubble generators are disposed in parallel at the first side and the second side.

15. The jet of claim 1 wherein the bubble generator(s) disposed at the first side are arranged along a first straight line, the bubble generator(s) disposed at the second side are arranged along a second straight line, and the first straight line is parallel to the second straight line.

16. A jet in flow communication with a reservoir comprising:
an orifice disposed above the reservoir;
a first bubble generator group disposed at a first side of the orifice for generating a first bubble in the reservoir, the first bubble is used as a virtual valve to restrict fluid to avoid flowing to the manifold;
a second bubble generator group disposed at a second side of the orifice for generating a second bubble in the reservoir, the second bubble squeezing fluid between the first bubble and the second bubble out of the orifice to form a droplet;
wherein the first bubble generator group or the second bubble generator group comprises at least two independently drivable bubble generators for generating the first bubble or the second bubble.

17. The jet of claim 16 wherein each of the bubble generators is a heater.

18. The jet of claim 16 wherein an interval between the orifice and one of the two bubble generators is different from an interval between the orifice and the other one of the two bubble generators.
